(19) United States
(12) Patent Application Publication
(10) Pub. No.: US 2005/0163953 A1
(43) Pub. Date: Jul. 28, 2005

(54) Laminated sheet for liner applications

(76) Inventor: Peter James Johnstone, Victoria (AU)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/510,924

(22) PCT Filed: Apr. 9, 2003
(86) PCT No.: PCT/AU03/00425

(30) Foreign Application Priority Data
Apr. 10, 2002 (AU) PS 1672

(51) Int. Cl. B32B 1/08

(52) U.S. Cl. 428/36.1; 156/184; 156/443; 442/1; 428/35.7

(57) ABSTRACT

This specification discloses apparatus and a method for producing a laminate material whether perforate or imperforate, the apparatus including a support frame having laminate take off means in the form of at least two conveyors having outwardly facing conveyor runs that are generally parallel to one another and carriage means arranged to travel about said laminate take off means to dispense one or more webs about said laminate take off means to form the laminate material in tubular form thereon and, in one embodiment, longitudinally severing the tubular formed laminate material to form a single layer of the laminate material.

### BACKGROUND OF THE INVENTION

1) Field of the Invention

The present invention relates to apparatus for, and a method of, making flexible sheeting or tubing from materials consisting of or including plastic film webs for various uses including liners for earth formed water retainers or water distributing systems such as ponds, dams, canals, irrigation ditches and the like.

The invention also has many other applications including the production of netting or mesh materials as well as land fill liners, land fill caps, large sheeting used in the building industry or as covers such as tarpaulins, hay, silage or grain covers, flexible piping or tubing, and storage tubes for moist products. These applications are exemplary in nature and other applications could equally exist. Depending on the application, the sheeting may be water impermeable or not.

2) Description of Related Art

The following description is given primarily in relation to the intended use as a liner for earth formed water retaining or distributing systems, however, it should be borne in mind that many other potential applications for the invention exist. It is generally well known that significant amounts of water is lost from such earth formed water retaining or distributing systems either by seepage through the base region or by evaporation from the water surface, particularly in hotter climates. The solution to this problem up until now has been to provide a water proof base liner formed from concrete or perhaps some flexible material such as rubber or, in the case of canals and irrigation ditches, to pipe the water flow underground using any available form of piping. It is also known to make relatively large sheets of plastics material for use as liners by on-site welding or gluing of large plastic panels. Such on-site welding or gluing has certain disadvantages including that it is awkward and cumbersome to undertake. All such arrangements have been found to be relatively expensive and have been undertaken only to a very limited extent. It has in fact been more often accepted that a certain amount of water loss from such earth formed water retainers/distribution systems was unavoidable and therefore should be tolerated. This view is increasingly becoming less acceptable particularly as the cost of water increases and with increasing recognition of the environmental damage caused by ground water seepage.

### BRIEF SUMMARY OF THE INVENTION

The objective therefore of the present invention is to provide an improved and relatively inexpensive method of making from plastics material film web, sheeting, tubing or net like materials for various applications with a minimum of or no joining of separate sections by welding or gluing. Preferably, but not exclusively, the method may be a aimed at producing liners for land fill sites, water retaining applications and for water distributing applications. The present invention also aims to provide apparatus for carrying out the method of the invention as well as various product applications for the materials produced by the methods and apparatus of this invention.

According to a first aspect of the present invention, apparatus is provided for making flexible laminated material either perforated or not perforated from web material, said apparatus including frame means having a laminated material take off mechanism associated therewith, and web material dispensing means for dispensing at least one first flexible plastic material film web in a first direction, wrapping means for wrapping at least one second flexible plastic material film web around the laminated material take off mechanism of said frame means to form said flexible laminated material with said first and second film webs being at least partially adhered to one another as said take off mechanism progressively removes said laminated material from the frame means. The term “web material” above is intended to include elongate sheet and preferably includes plastic film material. The apparatus thus described enables flexible tubes or sheet material of multiple layers adhered to one another whether continuous or in a net or mesh like form to be produced of theoretically any desired length by an easy and inexpensive method. Moreover, the width of the material produced can also theoretically be increased to any desired width. If desired the tubular material produced may be cut longitudinally so that it can be used as a single thickness sheet. It may also be used as a double thickness, or alternatively it may be used in tubular form. When used as a liner, water may be permitted to flow through the tubular structure or alternatively over the liner. Moreover, if the tubing or sheeting is produced in situ, water may be used to hold the liner in its end desired position.

In accordance with a further aspect of this invention, a method of making flexible laminated material from web material including dispensing at least one first flexible plastics material film web in a first direction and wrapping at least one second flexible plastic material film web in a plurality of spiral windings about a frame means to form said flexible laminated material by overlaying at least portions of the first film web with the second film web with said first and second film webs being at least partially adhered to one another while simultaneously moving the laminated material on said frame means towards a discharge zone from said frame means.

In accordance with a still further aspect of this invention, a method of lining a canal or the like is provided, the method including making a tubular liner material formed by spirally wound layers of at least one plastic film web with said layers adhered to one another, and laying said liner material along said canal. In the foregoing and hereinafter, the term canal is intended to include any earth formed or otherwise porous ditch, gutter or the like intended to convey water such as irrigation ditches.

In accordance with a still further aspect of this invention, there is provided a method of lining an earth formed water retaining means including making tubular liner material formed by spirally wound layers of at least one plastic film web with said layers adhered to one another, and laying said liner material in said retaining means. Preferably the tubular lining material is cut to form a single sheet prior to being laid in said retaining means.

In another aspect of this invention a net or mesh material is formed from a plurality of longitudinally disposed and laterally spaced webs interconnected by at least one spirally wound web formed into longitudinally spaced windings transversely disposed to said longitudinally disposed webs. Preferably a tubular form of the net or mesh material may be cut longitudinally to form at least one flat sheet of said net or mesh material.

In yet another aspect, a dam, pond or canal liner is provided formed by a liner material being spirally wound in overlapping layers of at least one plastic film web with said layers being adhered to one another.

In a still further aspect, the present invention provides a laminated film material formed from at least one plastic material web wound in overlapping spiral layers with said layers being adhered to one another to form a tubular structure, the thus formed tubular structure being cut longitudinally to form at least one flat sheet.

A still further aspect of this invention provides a flexible laminated material formed by at least one first flexible plastic material film web extending in a first direction and at least one second flexible plastic material film web spirally wound in a plurality of windings transversely crossing said at least one first flexible plastic material film web with each of said first and second film webs being at least partially adhered to one another to form said flexible laminated material.

Another aspect of this invention provides a laminated film material being formed from at least one plastic material web wound in overlapping spiral layers with said layers being adhered to one another to form a tubular structure, the thus formed tubular structure being cut longitudinally to form at least one flat sheet. Conveniently the aforesaid laminated material further includes at least one internal socket adapted to receive a flowable substance to act as a weight. Such a laminated material may have many applications including acting as a cover for building site applications, for pools or for silage pits. When acting as a cover the material may include at least one internal pocket adapted to receive a flowable material, for example water, to act as a weight. In an alternative preferred arrangement the initially formed tubular structure of the laminated material may be cut transversely with the transverse open ends being transversely sealed to define an internal closed cavity. Means to introduce or remove a flowable material (for example water), such as a spout with a closure cap, may be at least partially filled with the flowable material to act as a weight. Any desired division of the internal cavity may be made to provide a variety of space configurations that could act as weighted zones for the cover arrangement. Possible uses for such a cover arrangement might include swimming pool covers and covers for silage pits and the like.

### BRIEF DESCRIPTION OF THE SEVERAL VIEWS OF THE DRAWINGS

Further preferred aspects of this invention will become apparent from the following description given in relation to the accompanying drawings, in which:

FIG. 1 is a schematic perspective view of one preferred embodiment of this invention;

FIG. 2 is a schematic perspective view of a further preferred embodiment of this invention;

FIG. 3 is a schematic view similar to FIG. 2 and showing a still further preferred embodiment for making net or mesh material;

FIG. 3a is a schematic view of apparatus for producing string or thread like material from a plastic material film web;

FIG. 4 is a schematic illustration of laminated film made in accordance with the present invention used as a silage or other pit cover or as a pool cover; and

FIG. 5 is a schematic illustration similar to FIG. 4 showing the laminated film in a possible alternative cover embodiment.

### DETAILED DESCRIPTION OF THE INVENTION

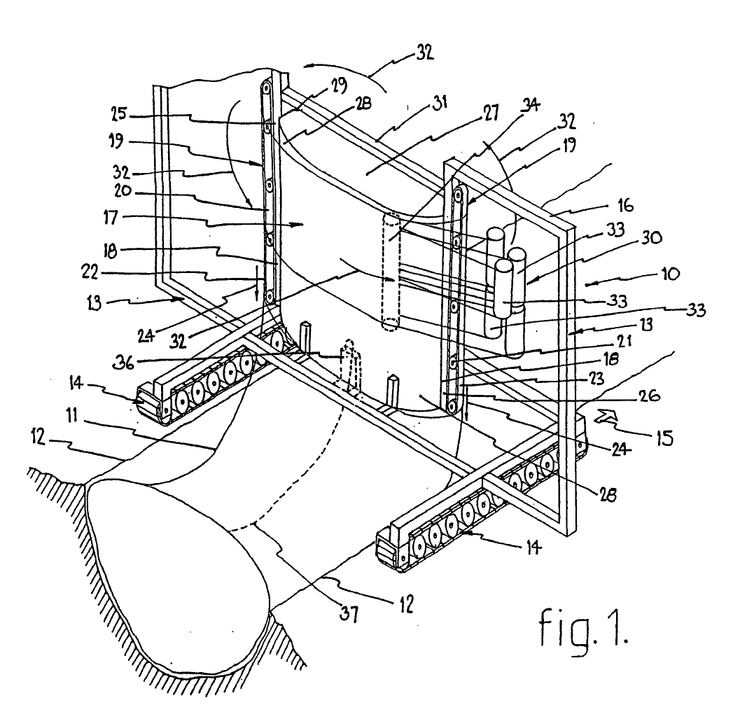

FIG. 1 of the annexed drawings illustrate schematically apparatus 10 for in situ production and placing of a liner 11 into a canal 12 or the like. It should be appreciated that many other applications of the principles of this invention are equally possible. For example, the apparatus need not be used in situ but could be used in a factory site to produce and store laminated material for subsequent use as a liner, or some other application as described in this specification.

Referring to FIG. 1, the illustrated apparatus 10 is arranged to straddle the canal 12 into which the liner 11 is placed. The apparatus 10 includes a support frame structure 13 supported by transport means 14 located on either side of the canal 12. The transport means 14 may be an endless track crawler system as illustrated, wheels, or any other suitable means. The transport means 14 is driven such that the apparatus 10 moves along the canal 12 in the direction of arrow 15. Depending from upper arms 16 of the support frame structure 13 is the liner forming apparatus 17 being free of obstructions at its lower end so that the liner 11 can be discharged downwardly therefrom either in tubular form or being cut longitudinally to form a single sheet. The liner forming apparatus 17 includes a frame means 18 with liner take off means 19 extending down each outer side thereof. In the illustrated embodiment, the take off means includes a pair of endless conveyors 20, 21 with outer runs 22, 23 moving downwardly in the direction of arrows 24. In one practical embodiment, the conveyors 20, 21 may be formed by endless chains each carrying a plurality of transversely disposed plates forming the surface of the conveyor. It will of course be appreciated that other constructions are also possible, Each of the conveyors 20, 21 may conveniently be driven from a central drive motor (not shown) mounted from the cross bar 31 with cooperating chain drives (also not shown) extending to the conveyors 20, 21 whereby the conveyors 20, 21 are driven at the same speed.

The frame means 18 includes a pair of spaced and downwardly depending support bars 25, 26 with a transverse wall structure 27 extending therebetween. The wall structure 27 may present either a flat outwardly facing surface or a convexly curved surface 28, 29 as illustrated. It should be appreciated that a continuous wall structure 27 as illustrated is not essential and, for example, it could be replaced by roller means to provide support for the film webs being laid to produce the liner as described hereafter. The roller means may be a single roller or a plurality of rollers disposed between the support bars 25, 26 for the conveyors 20, 21.

The liner forming apparatus 17 further includes plastic film web wrapping means 30 which is conveniently mounted on a carriage (not shown) arranged to travel in an orbit identified by arrows 32 around the frame means 18. The carriage may conveniently have provision for rotatably mounting a plurality of rolls 33 of plastic film web or other material webs suitable for making a suitable liner 11. Preferably, the film web used will have adhesive properties, either inherent (by virtue of the nature of the resin or resins used to produce same) or else by the addition of substances such as polyisobutene during the manufacturing process. The adhesive nature of the film web may be improved by heating the film. Alternatively the carriage may also carry adhesive application means to apply adhesive to the film immediately prior to depositing the film onto the liner forming apparatus 17. It is preferred that at least one film layer utilised in the liner 11 produced will be a low density polyethylene layer that has been pre-stretched to beyond its yield point to increase its length and decrease its thickness. Such films will increase the toughness and durability of the liner produced. Conveniently, the carriage may also carry a press roller 34 to press film webs against previously applied film layers to ensure that the layers of the liner produced do adhere to one another. Preferably the arrangement of film web layers is such that the outer two layers of the liner 11 are not self adhesive but the inner layers may be self adhesive or include reinforcing layers such as a reinforcing mesh web. If desired the film used to produce one surface of the liner may be a different colour to the film used to produce the other surface of the film. If desired, heat sealing means 35 may be provided to heat seal all layers of the liner together along longitudinally extending spaced lines as the liner 11 exits from the liner forming apparatus 17. Similar heat sealing devices may be provided on the reverse side of the apparatus not illustrated in the drawing. If desired, all layers of the liner produced may be heat sealed together circumferentially around the tubular structure produced. Moreover a heat sealing and liner cutting device 36 may be provided to optionally cut the liner 11 along a longitudinal line 37 to form same into a single sheet with the lateral edges heat sealed together.

In the illustrated embodiment, a liner 11 may be produced by moving the carriage of the film web wrapping means 30 about the frame means 18 and simultaneously moving the laid layers of film downwardly by operation of the take off means 19 whereby multiple layers of spirally wound film are produced to form a tubular liner 11 or, if desired, a single layer liner by cutting the tubular liner 11 as described above. Once fully installed in a canal 12 or the like, water may be caused to flow, either through the tubular structure of the liner, or over the liner when either doubled or of single thickness. Moreover, water may be used to hold the liner in position when desired.

It will be appreciated that many variations of the apparatus just described are possible and could be used depending on the circumstances and requirements without departing from the principles of this invention. For example, the apparatus may be built enabling the distance between the take off conveyors 20, 21 to be adjusted thereby enabling the width of the liner 11 produced to be increased or decreased as may be desired. In applications where it is desirable to weigh down the finished liner sheet, welding may be used to create compartments on the finished web into which compartments water or similar may be added between the laminated sheets, after which the compartments may be sealed by any convenient means, such as welding or tape. A still further possibility is to arrange in the liner or other product produced, layers of film webs cross wise to the film webs laid by the film web wrapping means 30. This might be achieved by placing a line of horizontal mandrels at the top of the frame and casting off film therefrom in a downwards direction as the liner is produced. This form of construction will improve the strength of the liner, or other product produced, in both the longitudinal and transverse directions.

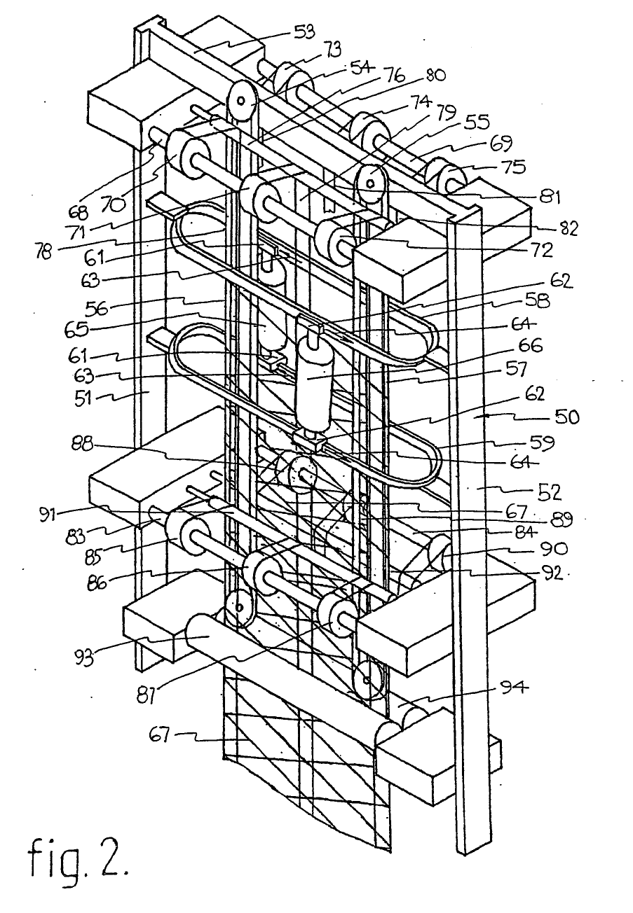

Referring now to FIG. 2, a possible alternative arrangement of apparatus for performing the present invention is illustrated. It will of course be appreciated that features disclosed and described with reference to FIG. 1 could also be employed in the arrangement of FIG. 2 and vice versa. As shown in FIG. 2, the apparatus includes a frame structure 50 having spaced side upright members 51, 52 and an upper cross bar 53. Vertically disposed endless conveyors 54, 55 are supported from the frame structure 50 each of which have outwardly facing conveyor runs 56, 57 that in use move downwardly at the same speed. The apparatus further includes a pair of vertically spaced guide tracks 58, 59 supported from the upright members 51, 52 that mount drivable carriage means 61 and 62 that are moved along the guide tracks 58, 59 in the direction of arrow 63, 64. The drivable carriage means 61, 62 carry between them rolls of plastic material film 65 and 66 to be dispensed around the conveyor runs 56, 57. Thus, as the rolls 65, 66 move around the guide tracks 58, 59, the film web is dispensed therefrom around the conveyor runs 56, 57 which are simultaneously moved downwardly. The film webs are thereby laid in overlapping spirals 67 to form a tube of overlapping web material adhered to one another. While two dispensing rolls have been illustrated, the arrangement will work with one roll alone or more than two rolls as may be needed depending upon the end product to be produced.

As is further shown in FIG. 2, spaced driven shafts 68 and 69 carry further rolls 70, 71, 72, 73, 74 and 75 of plastics material webs. Each web is passed over one of a pair of idler rollers 76 to travel downwardly therefrom. In the arrangement illustrated, the longitudinally downwardly extending webs 78, 79, 80, 81 and 82 are located inwardly of the spirally wound layers 67 dispensed from the rolls 65, 66. If considered desirable, a second lower set of driven shafts 83 and 84 carrying further rolls 85, 86, 87, 88, 89 and 90 of plastics material webs may be provided to lay a second web over idler rollers 91, 92 overlapping the first webs 78, 79, 80, 81 and 82 respectively. It will of course be appreciated that two or more vertically spaced sets of transverse (or spiral laying) film dispensing stations could be utilized whereby the longitudinally extending film webs could be sandwiched between two or more spirally wound layers.

A pair of press rollers 93, 94 may be provided to press the various layers together and if considered desirable other aspects as described with reference to FIG. 1 might also be included. For example, a divider member may be provided internally of the tube formation being produced against which pressure rollers 93, 94 may work. Such a divider member may be supported from below if the tube of laminated material is to be longitudinally cut by suitable serving means, or from above if it is not. Moreover, appropriate heat seal equipment or adhesive/gluing equipment could also be used as may be desired from time to time. It will of course also be appreciated that the apparatus disclosed and described above relative to FIG. 2 may be utilized to produce laminate film longitudinally extending webs that are spaced from one another in a transverse direction, at least partially or fully overlapping in transverse directions or may omit the longitudinally extending webs altogether. For the sake of clarity, the drive means for the various rollers and driver shafts carrying the film web rolls or rolls of other desired web materials, have been omitted from the drawing and the description as they do not form part of this invention.

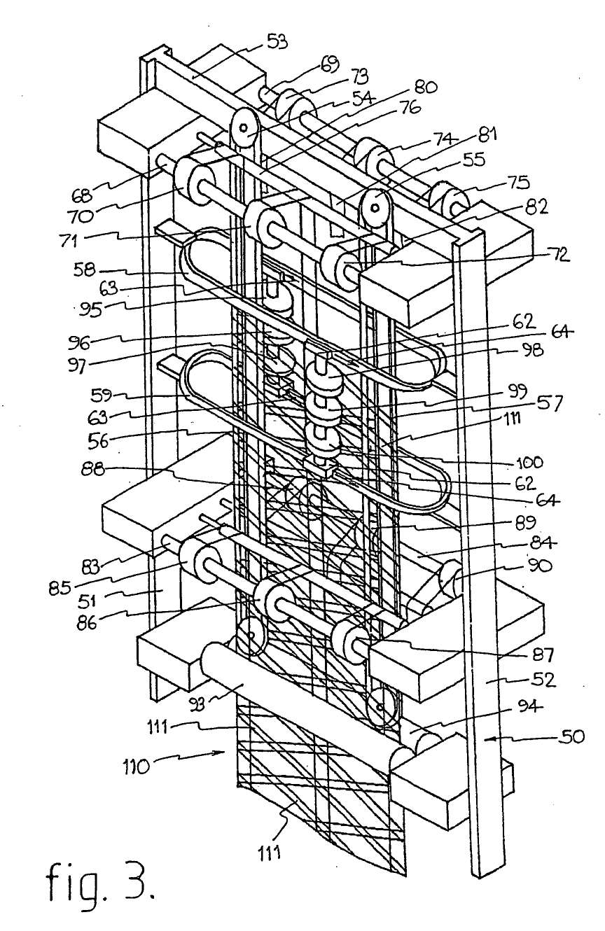

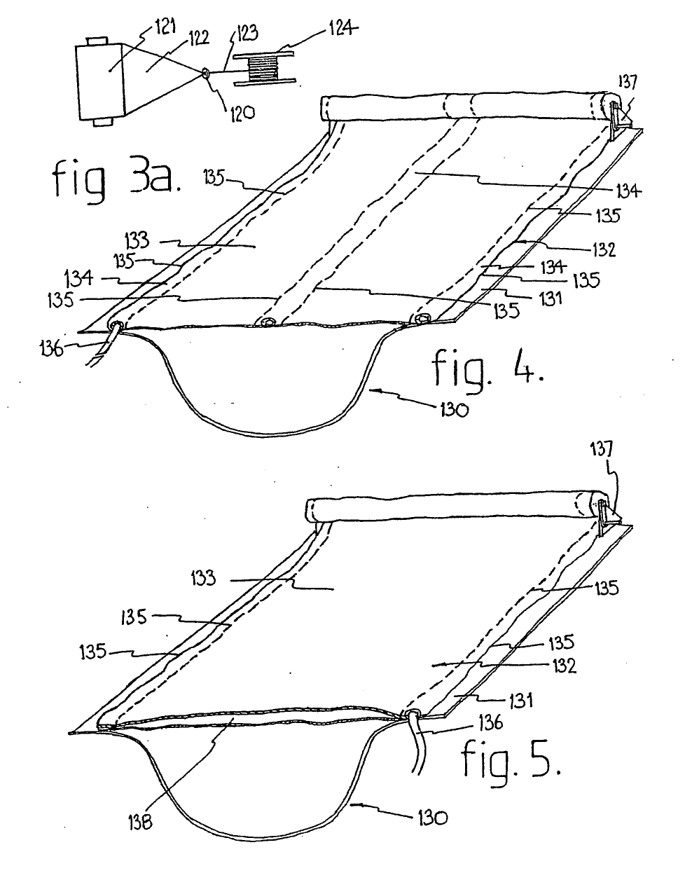

FIG. 3 is an arrangement similar to FIG. 2 except that single rolls of film material 56, 57 have been replaced by multiple vertically spaced rolls 95, 96, 97, 98, 99 and 100 of web material which are laid in spirals 111 similar to that of the webs from rolls 56, 57 but which are spaced vertically from one another to form a tube of mesh or net material 110. In the embodiment illustrated, the vertical webs are arranged outwardly or on either side of the spirals 111 but it will be appreciated that the reverse is also possible and other possible variations could also be included. As with the preceding embodiments, the features previously disclosed and described may also be utilized with this embodiment. Moreover, it is possible to run at least some or all of the web strip from the rolls 95 to 100 and 70 to 75 through one or more eyelets 120 from a roll 121 of film web material 122 as shown in FIG. 3a to form same into a thread like material 123. As shown in FIG. 3a, the thread like material 123 may be stored on a roll 124 for later use or alternatively, the production means can be included in the apparatus for producing the laminate material. It will of course be recognized that the cross-over points between the longitudinally extending webs or thread like material and the spirally wound webs or thread like material may be adhered to one another using adhesives or heat sealing techniques.

Referring to FIGS. 4 and 5, various preferred embodiments of covers for pits or pools are shown made from laminated material produced as described above. The pit may be used for silage making or for any other storage purpose. The pool 130 may be a swimming pool or any other water holding dam, pond or the like. The base of the pit or pool may be covered by a sheet of laminated material 131 if the underlying surface or base material is porous such as earth. The cover 132 for the pit or pool may, as shown in FIG. 4 be formed by a sheet of laminated material 133 made in accordance with this disclosure with integrally formed flexible pipes 134 formed between heat seal lines 135. In FIG. 4 longitudinally extending pipes 134 are illustrated, however, one or more transverse pipes 134 may also be provided including at the longitudinal ends of the cover 132. Appropriate fittings of a conventional nature including connection nozzles, taps, bungs or the like may also be provided to enable filling of or emptying each of the pipes 134 with water from a hose 136 or other water supply connection means. As is shown in FIG. 4 the cover 132 might be supported on a stand 137 to be for storage or dispensing purposes but such a stand 137 is not essential. FIG. 5 illustrates an alternative where the laminated material 133 may be formed as a tube with heat sealed edges and a water supply connection so that the space 138 might be filled or partially filled with water. It will of course be appreciated that many variations of covers of this type might be used utilizing laminated material as described in this specification.

1. Apparatus for making flexible laminated material either perforated or not perforated from web material, said apparatus including frame means having a laminated material take off mechanism associated therewith, and web material dispensing means for dispensing at least one first flexible plastic material film web in a first direction, wrapping means for wrapping at least one second flexible plastic material film web around the laminated material take off mechanism of said frame means to form said flexible laminated material with said first and second film webs being at least partially adhered to one another as said take off mechanism progressively removes said laminated material from the frame means.

2. Apparatus according to claim 1 wherein said web material wrapping means moves about said laminated material take off mechanism while wrapping said at least one first film web around said laminated material take off mechanism.

3. Apparatus according to claim 1 wherein said web material wrapping means remains in a stationary position and at least said laminated material take off means of said frame means rotates while wrapping said at least one first plastic film there around.

4. Apparatus according to claim 1 wherein said take off mechanism is disposed so as to remove said flexible laminated material from the frame means in a horizontal direction.

5. Apparatus according to claim 1 wherein said take off mechanism is disposed so as to remove said flexible laminated material from the frame means in an upright direction.

6. Apparatus according to claim 5 wherein the flexible laminated material is removed from said frame means in either a downwards direction or an upwards direction.

7. Apparatus according to claim 1 wherein said apparatus includes movement means and drive means to drive said movement means whereby said apparatus can be moved in a desired direction while forming said laminated material.

8. Apparatus according to claim 1 wherein said web material dispensing means dispenses said at least one first film web in a direction parallel to a movement direction imparted to said flexible laminated material by said laminated material take off mechanism.

9. Apparatus according to claim 8 wherein said flexible laminated material is formed as a net or mesh material with a plurality of openings between the web material.

10. Apparatus according to claim 1 wherein said web material wrapping means includes supply means for dispensing at least two said second film webs.

11. Apparatus according to claim 1 wherein a speed of wrapping the or each said second film web(s) by said wrapping means is related to the speed of removal of said flexible laminated material by said laminated material take off mechanism whereby the or each said second film web(s) supplied by said wrapping means is spirally wound in overlapping relationship in said flexible laminated material.

12. Apparatus according to claim 11 further including second web wrapping means arranged to apply further web material cross-wise relative to the second film web(s) applied by the first mentioned material web wrapping means.

13. Apparatus according to claim 1 wherein the laminated material take off mechanism includes at least two spaced endless conveyors having outer conveyor runs travelling in the same direction and speed about which the web material wrapping means wraps said at least one second plastic film to form said flexible laminated material.

14. Apparatus according to claim 13 further including press means to press at least an outer layer of said second plastic film web applied by said web material wrapping means against a previously applied layer.

15. Apparatus according to claim 8 wherein the web material dispensing means is configured to dispense a plurality of separate lengths of said first flexible plastic film webs, at least some of said separate lengths being transversely spaced from one another.

16. Apparatus according to claim 8 wherein the web material dispensing means is configured to dispense a plurality of separate lengths of said first flexible plastic film webs in overlapping relation.

17. Apparatus according to claim 15 wherein the web material wrapping means wraps at least one said second plastic film web about said laminated material take off mechanism to form spiral windings spaced longitudinally from one another and transversely crossing said separate lengths of the first plastic film webs.

18. Apparatus according to claim 1 wherein at least two separate lengths of said second plastic film webs are wrapped in overlapping spiral windings with at least one said first plastic film web dispensed in the longitudinal direction being disposed between said at least two separate lengths of said second plastic film webs.

19. Apparatus according to claim 1 wherein the web material dispensing means delivers at least two separate lengths of said first plastic film webs in overlapping relation whereby a said spiral winding of said second plastic film web is located between said at least two lengths of said overlapping longitudinally extending first plastic film web.

20. Apparatus according to claim 13 wherein the web material wrapping means includes a first supply means for supplying the second said plastic film about said outer conveyor runs and at least one further supply means for supplying at least one further said second plastic film, the first supply means wrapping said first plastic film at a tension level different to that of the or at least one said second plastic film(s).

21. Apparatus according to claim 1 wherein the web material dispensing means and the web material wrapping means supply the first plastic material film web and the second plastic material film web at differing tension levels.

22. Apparatus according to claim 1 wherein heat sealing means is provided to heat seal all layers of the flexible laminate material at at least longitudinally spaced positions along said laminated material.

23. Apparatus according to claim 22 wherein the heat sealing means heat seals all said layers of the flexible laminated material along at least one longitudinally extending seal line.

24. Apparatus according to claim 13 further including adjustment means to transversely adjust distance between the outer conveyor runs of said at least two spaced conveyors.

25. Apparatus according to claim 23 wherein said heat sealing means is adapted to form multiple transversely spaced said longitudinally extending seal lines.

26. Apparatus according to claim 23 further including cutting means to cut said laminated material longitudinally along heat sealed regions whereby each longitudinal edge region of the laminated material so cut is heat sealed.

27. Apparatus according to claim 1 further including cutting means to cut said material in a longitudinal direction.

28. Apparatus according to claim 1 further including adhesive application means to apply adhesive material to at least one said second flexible plastic material film web prior to wrapping said web material on said frame means.

29. Apparatus according to claim 1 further including adhesive application means to apply adhesive material to said web material applied over the laminated material take off means prior to wrapping a said second plastic material film web over said adhesive material.

30. A method of making flexible laminated material from web material including dispensing at least one first flexible plastics material film web in a first direction and wrapping at least one second flexible plastic material film web in a plurality of spiral windings about a frame means to form said flexible laminated material by overlaying at least portions of the first film web with the second film web with said first and second film webs being at least partially adhered to one another while simultaneously moving the laminated material on said frame means towards a discharge zone from said frame means.

31. A method according to claim 30 wherein said first direction is in the same direction as movement of the laminated material towards said discharge zone.

32. A method according to claim 30 wherein said frame means includes at least two conveyors, the web material being wrapped onto said conveyors and conveyed thereby from said frame means.

33. A method according to claim 30 wherein at least two said second plastic film webs are simultaneously wrapped about said frame means.

34. A method according to claim 33 wherein said at least two said second plastic film webs are self adhesive whereby they will adhere to a previously wrapped layer.

35. A method according to claim 30 wherein flexible reinforcing web material forms at least one of said web material used to make the flexible laminated material.

36. A method according to claim 35 wherein the reinforcing web material is of a mesh construction.

37. A method according to claim 30 wherein the or each said first and second film webs are a low density polyethylene film pre-stretched to beyond its yield point to increase its length and decrease its thickness.

38. A method according to claim 30 wherein adhesive is applied between layers of said web material wrapped on said frame means.

39. A method according to claim 30 wherein layers of said flexible laminated material are heat sealed together at at least longitudinally spaced locations along at least one longitudinally extending seal line.

40. A method according to claim 39 wherein a plurality of said seal lines are formed circumferentially spaced about said flexible laminated material.

41. A method according to claim 30 wherein cutting means is provided to cut the flexible laminated material along at least one longitudinally extending cut line to thereby form a single layer of said flexible laminated material.

42. A method according to claim 41 wherein layers of each cut edge zone of the flexible laminated material are heat sealed together.

43. A method of lining a canal or the like including making tubular liner material formed by spirally wound layers of at least one plastic film web with said layers adhered to one another, and laying said liner material along said canal.

44. A method according to claim 43 wherein said tubular liner material is positioned in said canal as a double thickness.

45. A method according to claim 44 wherein water flow in said canal is arranged to flow within the tubular liner material whereby a portion of said liner material overlies said water flow.

46. A method according to claim 43 wherein said tubular liner material is cut along a longitudinally extending line whereby said liner material is positioned in said canal as a single thickness.

47. A method according to claim 43 wherein said tubular liner material is formed in situ and laid directly into said canal.

48. A method of lining an earth formed water retaining means including making tubular liner material formed by spirally wound layers of at least one plastic film web with said layers adhered to one another, and laying said liner material in said water retaining means.

49. A method according to claim 48 wherein said tubular liner material is cut to form a single sheet prior to being laid in said water retaining means.

50. A net or mesh material formed from a plurality of longitudinally disposed and laterally spaced webs interconnected by at least one spirally wound web formed into longitudinally spaced windings transversely disposed to said longitudinally disposed webs.

51. A net or mesh material according to claim 50 wherein a tubular form of said net or mesh material is cut longitudinally to form at least one flat sheet of said net or mesh material.

52. A dam, pond or canal liner formed by a liner material being spirally wound in overlapping layers of at least one plastic film web with said layers being adhered to one another.

53. A dam, pond or canal liner according to claim 52 wherein a tubular form of said liner is cut longitudinally to form at least one flat sheet.

54. A dam, pond or canal liner according to claim 52 further including one or more webs extending in a longitudinal direction transverse to said spirally wound overlapping layers.

55. A dam, pond or canal liner according to claim 54 wherein a plurality of said webs extending in the longitudinal direction are provided spaced from one another.

56. A dam, pond or canal liner according to claim 54 wherein a plurality of said webs extending in the longitudinal direction are provided and overlap one another.

57. A laminate film material, the laminate film material being formed from at least one plastic material web wound in overlapping spiral layers with said layers being adhered to one another, the thus formed tubular structure being cut longitudinally to form at least one flat sheet.

58. A laminate film material according to claim 55 further including at least one longitudinally extending plastic material web positioned such that the or each said spirally wound layer is disposed transverse to the or each said longitudinally extending plastic material web.

59. A flexible laminated material formed by at least one first flexible plastic material film web extending in a first direction and at least one second flexible plastic material film web spirally wound in a plurality of windings transversely crossing said at least one first flexible plastic material film web with each of said first and second film webs being at least partially adhered to one another to form said flexible laminated material.

60. A flexible laminated material according to claim 59 wherein a plurality of said first film webs are provided.

61. A flexible laminated material according to claim 59 wherein a plurality of said second film webs are provided.

62. A flexible laminated material according to claim 59 wherein the or each of said first film web(s) extend in a longitudinal direction of the flexible laminated material.

63. A flexible laminated material according to claim 59 wherein said first film web is spirally wound in a plurality of windings.

64. A laminated material according to claim 59 wherein a tubular form of said laminate film is cut longitudinally to form at least one flat sheet.

65. A laminated film material being formed from at least one plastic material web wound in overlapping spiral layers with said layers being adhered to one another to form a tubular structure, the thus formed tubular structure being cut longitudinally to form at least one flat sheet.

66. A laminated material according to claim 65 further including at least one internal pocket adapted to receive a flowable substance to act as a weight.

67. A cover arrangement formed from a laminated film material, the laminated film material being formed from at least one plastic material web wound in overlapping spiral layers with said layers being adhered to one another, said cover arrangement further including at least one internal pocket adapted to receive a flowable substance to act as a weight.
